(19) United States
(12) Patent Application Publication
(10) Pub. No.: US 2018/0216464 A1
(43) Pub. Date: Aug. 2, 2018

(54) METHOD OF REPAIRING A BLISK

(71) Applicant: General Electric Company, Schenectady, NY (US)

(72) Inventors: Keith Edward Bezanson, Cold Spring, KY (US); William E. Morgan, Cincinnati, OH (US); Eric Gebert, Hamilton, OH (US); Drew Michael Chmura, Liberty Township, OH (US); Donna Tylicki Walters, West Chester, OH (US); Stanford Verigood, Hamilton, OH (US); Suhas Prabhakar Vaze, Loveland, OH (US); Timothy J. Trapp, Wyoming, OH (US); Donovan O. Buckley, Delmar, NY (US); Hans R. Wagner, Hamilton, OH (US); Brian David Church, Liberty Township, OH (US); Gary Edward Trewiler, Loveland, OH (US); Gregory Christopher Firestone, Pickerington, OH (US); James A. Hahn, Loveland, OH (US); Jeffrey James Root, Columbus, OH (US); Seth Carl Shira, Cardington, OH (US)

(21) Appl. No.: 15/420,132

(22) Filed: Jan. 31, 2017

(51) Int. Cl. F01D 5/00; B23P 6/00; B23K 26/34; F01D 5/02; F04D 29/32; G06F 17/50

(52) U.S. Cl. CPC F01D 5/005; B23P 6/002; B23K 26/34; F01D 5/02; F05D 2230/235; G06F 17/50; B23P 2700/13; F05D 2230/80; F05D 2230/40; F04D 29/321

(57) ABSTRACT

A method of repairing a blisk having a hub with circumferentially spaced blades. The method can include removing a portion of a blade and replacing the portion with a replacement piece. The method can further include welding the replacement portion to the blade. The method can further include at least one of inspecting the weld after the completion of the weld and prior to heat treatment, dimensionally inspecting the replacement piece after machining, peening the blade, and surface finishing the replacement piece.

### BACKGROUND OF THE INVENTION

Turbine engines, and particularly gas or combustion turbine engines, are rotary engines that extract energy from a flow of combusted gases passing through the engine onto a multitude of rotating turbine blades. Gases are compressed by a compressor, combusted in a combustor, and then passed through a turbine. There can also be a bypass fan that forces air around the core of the engine.

The compressor, turbine, and bypass fan have a similar construction. Each have a rotor assembly included in a rotor disk and a set of blades extending radially outwardly from the rotor disk. The blades can be integral with and metallurgically bonded to the disk, forming a blisk (bladed disk, also sometimes known as “integrally bonded rotor” or IBR). The blisk can also be formed of one solid piece of metal as a monolithic structure.

During manufacture or during operation, one or more of the blades of the blisk can be damaged, for example by particles in the gas flow. Conventionally, if the damage has nicks, dents, or local loss of material, the blade is repaired. The repair can include heat treatment which ensures properties of damaged areas while not reducing properties of other areas of the blisk.

### BRIEF DESCRIPTION OF THE INVENTION

In one aspect, the present disclosure relates to a method of repairing a blisk having a hub with circumferentially spaced blades, the method comprising removing a damaged portion of a blade, probing a blade to determine a three-dimensional shape of the blade, morphing the remaining portion of the blade to create a computer-generated replacement piece, determining whether the computer-generated replacement piece is contained within a raw replacement piece, securing to the blade in place of the removed damaged portion the raw replacement piece, establishing three dimensions of an existing surface of the blade, extrapolating a 3-D contour from the three dimensions of the computer-generated replacement piece and the three dimensions of the existing surface of the blade, and shaping the raw replacement piece to match the extrapolated 3-D contour.

In another aspect, the present disclosure relates to a method of repairing a blisk having a hub with circumferentially spaced blades, the method comprising severing a damaged portion of a blade to define a severed edge, determining three dimensions of a computer-generated replacement piece, securing to a remaining portion of the blade in place of the removed damaged portion a raw replacement piece greater in size in three dimensions than the damaged portion, determining whether the three dimensions of the computer-generated replacement piece are contained within the raw replacement piece, welding the raw replacement piece to the remaining portion of the blade along the severed edge, establishing three dimensions of an existing surface of the blade, extrapolating a 3-D contour from the three dimensions of the computer-generated replacement piece and the three dimensions of the existing surface of the blade, and shaping the raw replacement piece to match the extrapolated 3-D contour.

### BRIEF DESCRIPTION OF THE DRAWINGS

In the drawings:

FIG. 1 is schematic cross-sectional diagram of a gas turbine engine for an aircraft.

FIG. 2 is a perspective view of a blisk.

FIG. 3 is perspective view of a blade of the blisk from FIG. 1 with a damaged portion.

FIG. 4 is the blade from FIG. 2 with exemplary removal lines.

FIG. 5 is the blade from FIG. 2 with a portion removed.

FIG. 6 is the blade from FIG. 2 with a computer-generated replacement piece.

FIG. 7 is the blade from FIG. 2 with a raw replacement piece.

FIG. 8 is the blade from FIG. 2 with the raw replacement piece held in place.

FIG. 9 is the blade from FIG. 2 with the raw replacement piece welded to a remaining portion of the blade.

FIG. 10 is a repaired blade with the raw replacement piece from FIG. 7 shown in phantom.

FIG. 11 is a flow chart of a method for repairing a blade on a blisk.

### DETAILED DESCRIPTION OF THE INVENTION

Aspects of the disclosure described herein are directed to a method of repairing a blisk. For purposes of illustration, the present disclosure will be described with respect to the bypass fan for an aircraft gas turbine engine. It will be understood, however, that aspects of the disclosure are not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of the disclosure. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

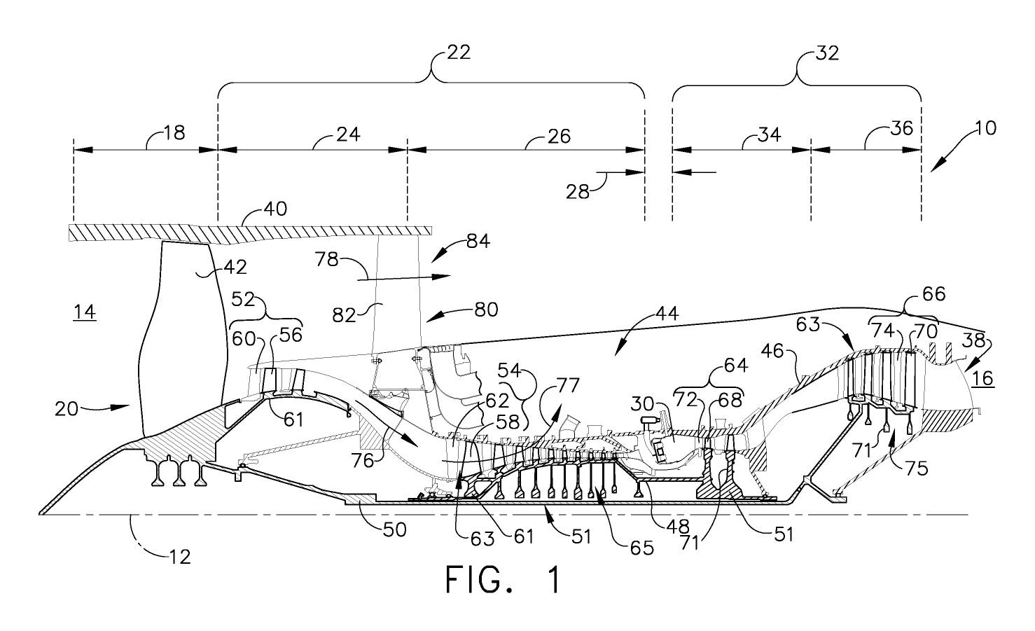

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The blades 56, 58 can be metallurgically bonded to the disk 61 to form a monlolithic structure of a blisk 65. The blisk 65 is one piece when manufactured. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The blades 68, 70 can be metallurgically bonded to the disk 71 to form a monolithic structure of a blisk 65. The blisk 65 is one piece when manufactured. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

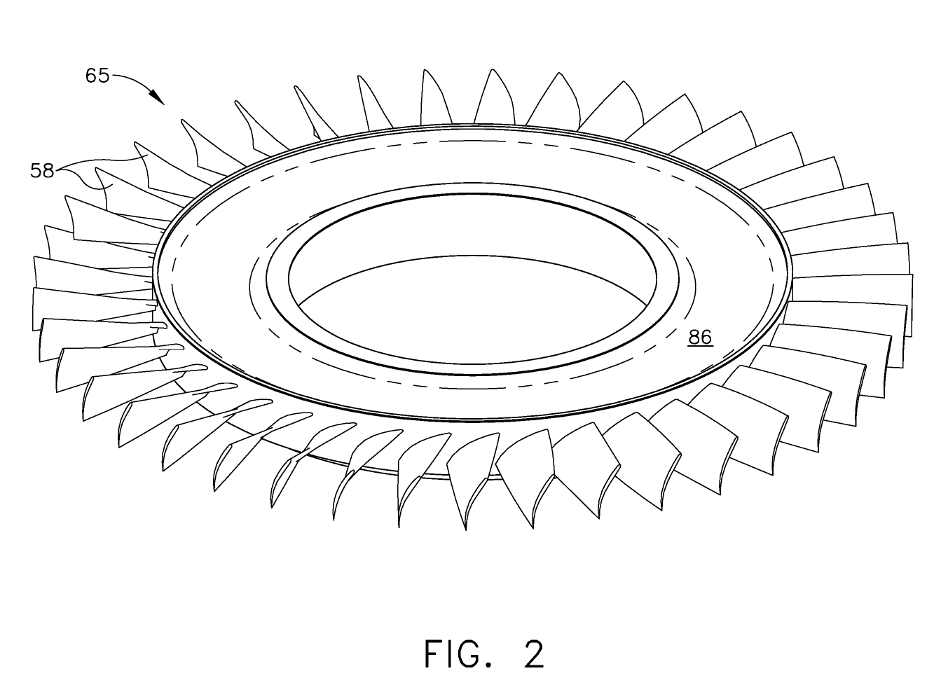

FIG. 2 illustrates an exemplary blisk 65, comprising a central disk hub section 86 and a plurality of blades 58. The central hub section 86 and the blades 58 are from a single piece of metal and the blades 58 are metallurgically bonded to the hub section 86 such that the blisk 65 is formed and machined in one piece. The blisk 65 can be made of any operable material, such as by way of non-limiting example, titanium-based, a nickel-based, cobalt-based, or iron-based superalloy. Each part of the blisk 65, while machined in one piece, can be made from different alloys or a combination of by way of non-limiting example the aforementioned alloys. It should be understood that the blisk 65 can be in any section of the engine 10 including the fan, compressor, or turbine sections 18, 22, 32.

For the process described herein, the entire blisk 65 is positioned in a machine (not shown), for example a multi-axis milling machine. The blisk 65 undergoes on-machine probing where the machine functions as a coordinate measuring machine (CMM). The blisk 65 is placed in an existing computer coordinate system of the CMM. Data points that represent the positions of blisk 65 datums & blades are determined and uploaded to the CMM control computer. A computer aid drawing (CAD) model of the designed blisk 65 can be uploaded into the coordinate system of the CMM. Any changes to the blades 58 during operation, including but not limited to movement, blade twist, or damage, are recorded by comparing the CAD model of the blisk 65 to the existing blisk 65 data points recorded during on-machine probing. The existing blisk 65 data points together create an existing CAD model of the blisk 65.

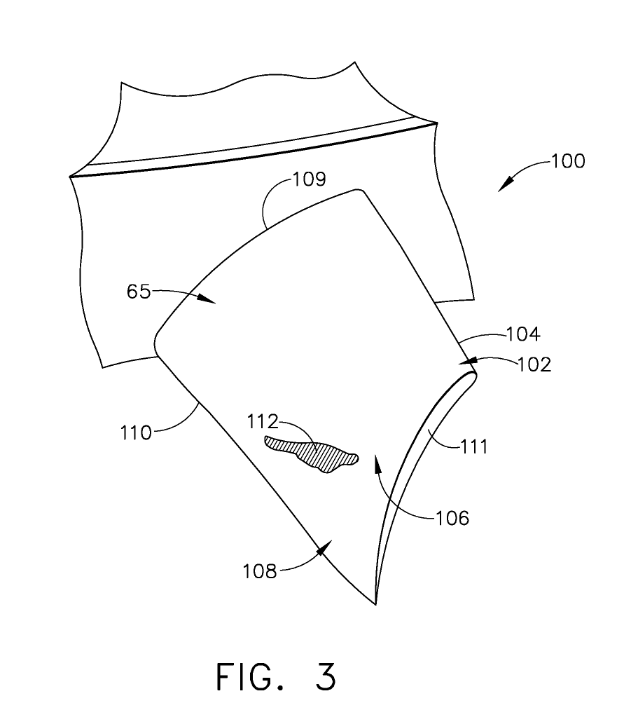

FIG. 3 illustrates an exemplary blisk airfoil 100, which by way of non-limiting example can be the blade 58 or any other rotating airfoil in the engine, comprising a leading edge section 102, including a leading edge 104, a main body section 106, and a trailing edge section 108, including a trailing edge 110. The blade 58 spans radially from a root 109 to a tip 111. A portion of the blade 58 spanning the trailing edge section 108 and the main body section 106 has a damaged portion 112. The damaged portion 112 is for illustrative purposes only and can be located anywhere on the blade 58. By way of non-limiting example the damaged portion 112 can include a missing part, a curled portion of material, a broken tip, an indentation, or a hole in the blade 58 that is beyond a surface scratch. The damaged portion 112 can occur due to debris including but not limited foreign object debris such as particles in the pressurized airflow 76 or domestic object debris from particles emanating from within the engine. The damaged portion is found during the on-machine probing process described herein. It is also contemplated that the damaged portion can be identified during a routine inspection of the engine 10 or a blisk 65 inspection.

Upon discovering a damaged portion 112 of the blade 58 a method for repairing the blade 58 will be discussed and illustrated using the following figures.

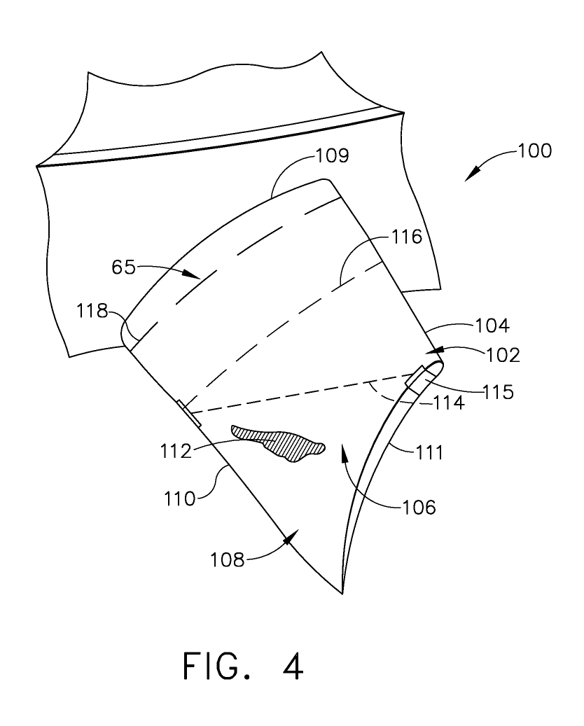

FIG. 4 is the same exemplary blade 58 from FIG. 3 with a cut line 114 depicted. It should be understood that the cut line 114 can be in any direction, by way of non-limiting example it can be located below the damaged portion 112 along a horizontal 116 or even near the root 109 along a horizontal 118. Also, the cut line 114 need not be planar, it can be, but is not limited to, a “J” shape.

A cropping fixture 115 can be secured to the blade 58 to ensure the cut line 114 is determined on the actual blade (not the CAD representation of the actual blade) and based on the actual damaged area on the blisk 65 while mounted in the machine. Removal of the damaged portion 112 of the blade 58 is performed along the cut line 114. The cut line 114 should be positioned such that the damaged portion 112 and additional material surrounding the damaged portion 112 are removed.

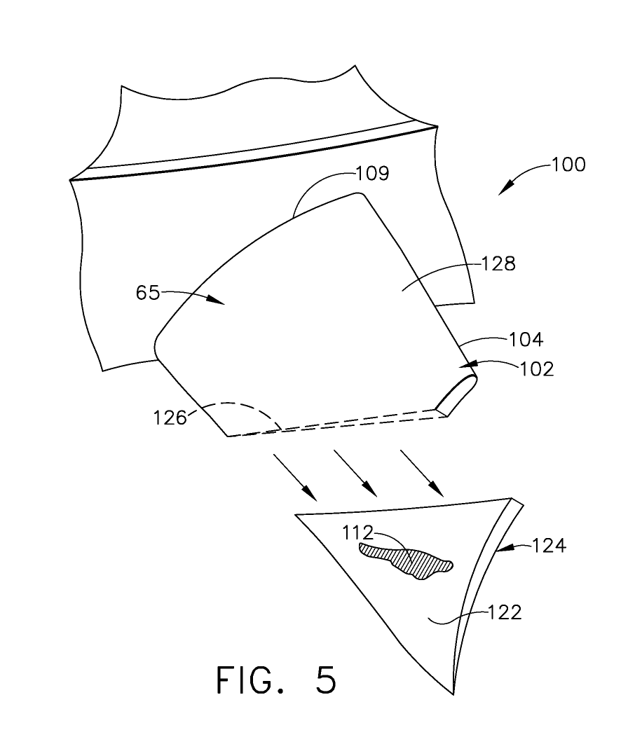

Turning to FIG. 5, removing the damaged portion 112 includes severing the damaged portion 112 along the cut line 114 such that a margin of non-damaged blade 122 is included to form a severed portion 124. Severing the damaged portion 112 can be accomplished by way of non-limiting example using shearing, sawing and abrasive cutting, machining, plasma arc cutting (PAC), powder metal cutting with iron-rich powder, or carbon arc cutting.

Upon removal of the severed portion 124, a severed edge 126 is formed along a remaining portion 128 of the blade 58. The severed edge 126 and its vicinity are then treated to remove all surface contaminants and oxides. Treating the severed edge 126 can include, by way of non-limiting example, grinding, machining, or abrasive blasting. In certain implementations, treating the severed edge 126 and its vicinity can include chemically milling, acid etching, or swab etching the severed edge 126. Treating can be conducted in an automated manner.

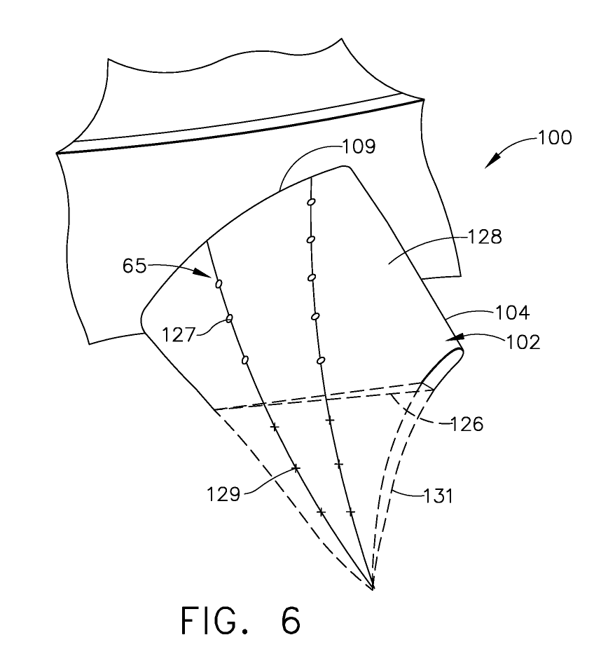

FIG. 6 illustrates probing the blade 58. Data points 127 along the remaining portion 128 are used to determine data points 129 representing a computer-generated replacement piece 131 in three dimensions. This is accomplished by geometric morphing, herein simply referred to as morphing, the existing data points 127 into data points 129 and producing a CAD model of the computer-generated replacement piece 131. On-machine probing the blade 58 includes determining dimensions that vary along any of a length, width, or height of the computer-generated replacement piece 131. Specifically, the length, width, and height of the computer-generated replacement piece 131 is not constant and can vary such that the width, for example, is thicker at the main body section 106 than at the trailing edge section 108.

If the blade is cut-off near the root 109 along horizontal 118, complementary surfaces on the adjacent blades would be probed to obtain deviation. Specifically, the deviation required for a convex side of the severed portion 124 would be obtained by measuring a concave side of an adjacent blade 58 and reversing its sign. A positive deviation on the concave side of the adjacent blade 58 would become a negative deviation on the convex side of the severed portion 124 in the interpolated section. The concave side of the severed portion 124 would be obtained from the convex side of the adjacent blade 58 utilizing the same approach. Any lead or trail edge deviations would be computed based on curve fittings for required thickness.

It should be further understood that probing the blade 58 can occur before removing the damaged portion 112 such that the computer-generated replacement piece 131 is based on the original blade dimensions. A combination of probing before removing the damaged portion 112 and after removing the damaged portion 112 as described herein is also contemplated.

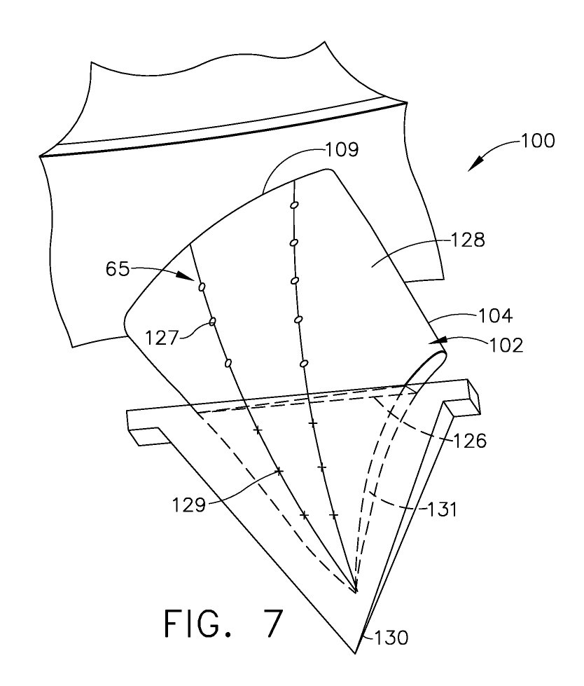

FIG. 7 depicts a raw replacement piece 130, pre-formed and greater in size in three dimensions, length, width, and height, when compared to the severed portion 124. It can be contemplated that the raw replacement piece 130 is greater in dimension in at least two dimensions. The raw replacement piece 130 can be formed by machining a piece from a Spare PArt Drawing (SPAD) suitable for the blade 58 in need of the raw replacement piece 130. Adaptive machining can be used to form the raw replacement piece 130 where the raw replacement piece 130 is machined based on one or more parameters of the original blade 58 and based on one or more original design parameters of the component. Deformation processes like forging or additive manufacturing processes like direct metal laser melting can also be used to form the raw replacement piece 130.

During operation, it is contemplated that the blade 58 can twist and move out of the original design location. The raw replacement piece 130 can be larger in three dimensions than the severed portion 124, but due to twisting, all three dimensions of the computer-generated replacement piece 131 may not be contained within the raw replacement piece 130. Therefore, the method includes determining whether the three dimensions of the computer-generated replacement piece 131 are contained within the raw replacement piece 130. The determining can occur prior to securing the blade in place using a computer model of the raw replacement piece 130 and that of the computer-generated replacement piece 131. It is also contemplated that the raw replacement piece 130 is secured to the blade 58 prior to the determining and that whether the computer-generated replacement piece 131 fits is determined based on actual placement of the raw replacement piece 130 on the blade 58.

In an event where the computer-generated replacement piece 131 is not fully contained within the raw replacement piece 130, the raw replacement piece 130 is adjusted in order to fully contain the computer-generated replacement piece 131. Adjusting the raw replacement piece includes increasing at least one of the three dimensions. Adjusting can be done by simply moving the raw replacement piece 130 to contain the computer-generated replacement piece 131. It is contemplated that adjusting of the raw replacement piece can be guided by custom-built indicators and vision-based inspection tools. It is also contemplated that adjusting the raw replacement piece 130 can include machining the raw replacement piece 130 to fully contain the computer-generated replacement piece 131. Furthermore, a new raw replacement piece 131 with appropriately modified geometry can be selected and used.

The raw replacement piece 130 can include run-on and run-off tabs 132, 134 to promote weldability—it can also include other features (not shown) like localized end effectors, projections, and thickened body regions. The raw replacement piece 130 is the same material composition, by way of non-limiting example titanium-64 alloy, as the remaining portion 128 of the blade 58. A controlled gap 136 is produced between the remaining portion 128 and the raw replacement piece 130 when the raw replacement piece 130 is prepared to be affixed to the remaining portion 128. A controlled gap 136 is required for welding purposes to ensure proper adhesion between the raw replacement piece 130 and the remaining portion 128. The extent of the controlled gap 136 is based on the method of affixing the raw replacement piece 130 to the remaining portion 128 for filling the controlled gap 136 with weldment.

It is further contemplated that the material composition of the raw replacement piece 130 is different than the remaining portion 128. A raw replacement piece 130 made of an optimized or a functionally-graded material, by way of non-limiting example, nickel alloy Inconel 718 could work with a remaining portion 128 formed from direct age 718 alloy. In some applications it has been found that nickel alloy Inconel 718 is better for withstanding rub, when the blade 58 hits a shroud. Also, it is further contemplated that replacement piece 130 can be custom-made using an additive process, which can include, but is not limited to direct metal laser melting.

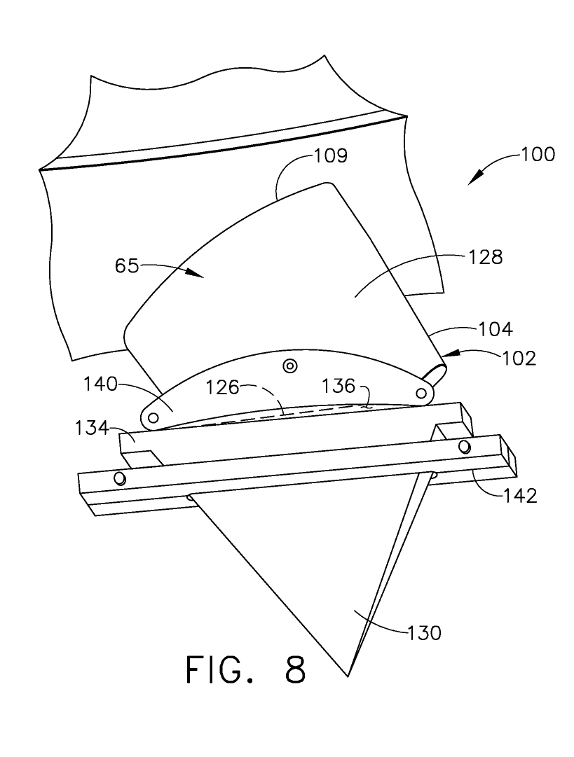

Turning to FIG. 8, an airfoil fixture 140 and a SPAD fixture 142 are secured to the blade 58 and to the raw replacement piece 130 respectively, and ultimately to one another, to prepare the blade 58 for welding. Note that airfoil fixture 140 and a SPAD fixture 142 allow several controlled gaps to be set or adjusted including but not limited to controlled gap 136 and controlled gap between SPAD tab ramps and airfoil edges. Prior to securing, the raw replacement piece 130 is cleaned and prepared in a similar manner to severed edge 126 and its vicinity as described in [0041]. The raw replacement piece 130 is secured to the blade 58 in place of the severed portion 124 (FIG. 5) by welding the raw replacement piece 130 to the remaining portion 128 along the severed edge 126.

Electron beam welding can be performed in a case where a line of site is available along the severed edge 126. By way of non-limiting example, laser beam welding, similar to electron beam welding, can be applied. Laser beam welding has a high power density which results in a small heat-affected zone. In a case where line of site is not fully available, by way of non-limiting example when the cut line is closer to the hub section 86, solid state resistance welding (SSRW) can be performed. By way of non-limiting example, translational friction welding (TFW), or solid state resistance welding (SSRW), can be applied. With TFW, mechanical friction is utilized between two workpieces in relative motion to one another and a lateral force is applied to plastically displace and fuse the workpieces together. With SSRW electrical current is passed between the two workpieces that is concentrated at the interface while a lateral force is applied to plastically displace and fuse the workpieces together. By way of non-limiting example, laser beam welding with special-purpose reflective optics to manipulate the laser beam and overcome the absence of line of sight can also be used.

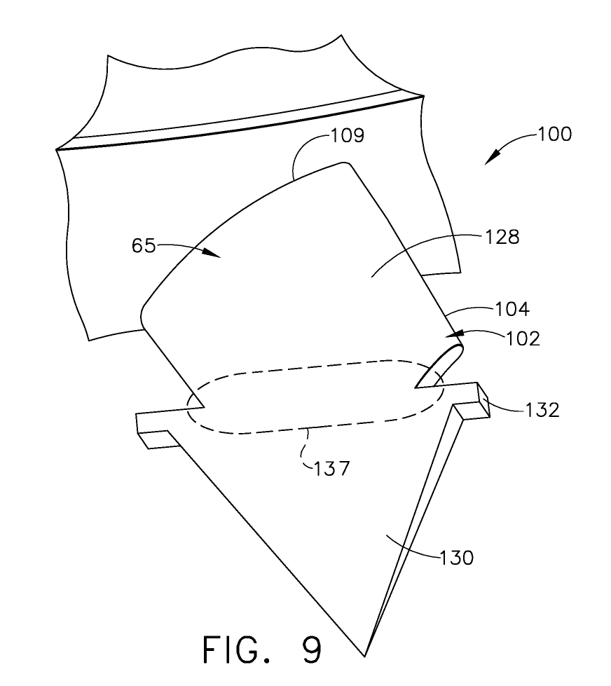

Turning to FIG. 9, welding the raw replacement piece 130 to the remaining portion 128 is complete. A post-weld inspection occurs using, by way of non-limiting example, visual, fluorescent penetrant, ultrasonic, eddy current or X-ray to examine a welded area 137 for any imperfections. Inspections can occur at any point during the process and are not limited to occur only after the welding step.

A localized post-weld heat treatment is performed at the welded area 137 to, by way of non-limiting example, reduce and redistribute residual stresses in the material of both the remaining portion 128 and the raw replacement piece 130 that can be introduced by welding. An inductive or electrical resistance generated heat, by way of non-limiting example, is localized and confined to the welded area 137 such that the temperature required for stress relieving is produced in the welded area 137 only.

Upon completion of the localized post-weld heat treatment, oxygen-enriched alpha case can be produced on the surface, specifically in titanium and titanium alloys when they are exposed to heated air or oxygen. Alpha case is hard and brittle and can produce micro-cracks if left on the blade 58. An alpha case removal step is performed on the heat-treated replacement piece 130 in the welded area 137 to prevent any future micro-cracks that can result from residual alpha case. Removal of alpha case can be done in a similar way of treating the severed edge 126 (FIG. 8) before the welding. By way of non-limiting example grinding, machining, abrasive blasting, chemical milling, acid etching, or swab etching the welded area 137 can remove the alpha case.

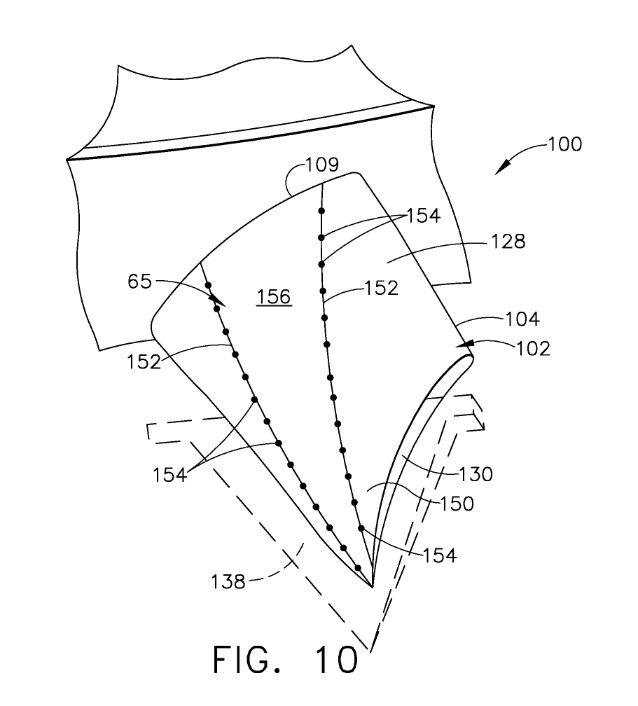

Turning to FIG. 10, the blade 58 is now one continuous repaired blade 150 made up of the original remaining portion 128 and the raw replacement piece 130. The remaining portion 128 is morphed is such a way as to ensure smooth transition between the remaining portion 128 and the computer-replacement piece 131. The raw replacement piece 130 is shaped such that excess portions 138 are removed to form the repaired blade 150 to the shape represented by the combination of the remaining portion 128 and the computer generated-replacement piece 131 (FIG. 7). A set of surface points 154 are used to establish three dimensions of an existing surface 156 of the repaired blade 150.

A 3-D contour 152 is extrapolated using the three dimensions from the computer-generated replacement piece 131 and the three dimensions of the existing surface 156 of the repaired blade 150. Shaping comprises removing the excess portions 138 until the raw replacement piece 130 and the remaining portion 128 match the extrapolated 3-D contour 152.

The shaping process can include adaptive machining where a collection of data points are used to select the process of milling the blade 58 as close to the original shape as possible. As described herein, the data points are from the original CAD model of the blade, the computer-generated replacement piece 131, and the original blade 58. The data points are collected and the set of surface points 154 is created to drive morphing the shape of the repaired blade 150. While the computer model of the blade would be the best design, the original blade 58 has undergone changes from its original shape because of operating conditions. Morphing allows for both the optimal design to be considered as well as the existing conditions to produce a final product having both computer and original sets of data.

Removing the excess portions 138 includes machining the excess material of the raw replacement piece 130 away according to the extrapolated 3-D contour. The final repaired blade 150 is therefore an airfoil shape extrapolated from the original blade 58 and the designed CAD version of the blisk airfoil. Upon completion of shaping the airfoil, a coordinate measuring machine is used to measure the physical geometrical characteristics of the repaired blade 150 to ensure that it meets design requirements for continued airworthiness.

The repaired blade then undergoes peening, where it is heat blasted to improve the material properties of the repaired blade 150. Finally, a surface finish operation, by way of non-limiting example tumbling, is performed to finish the repaired blade 150.

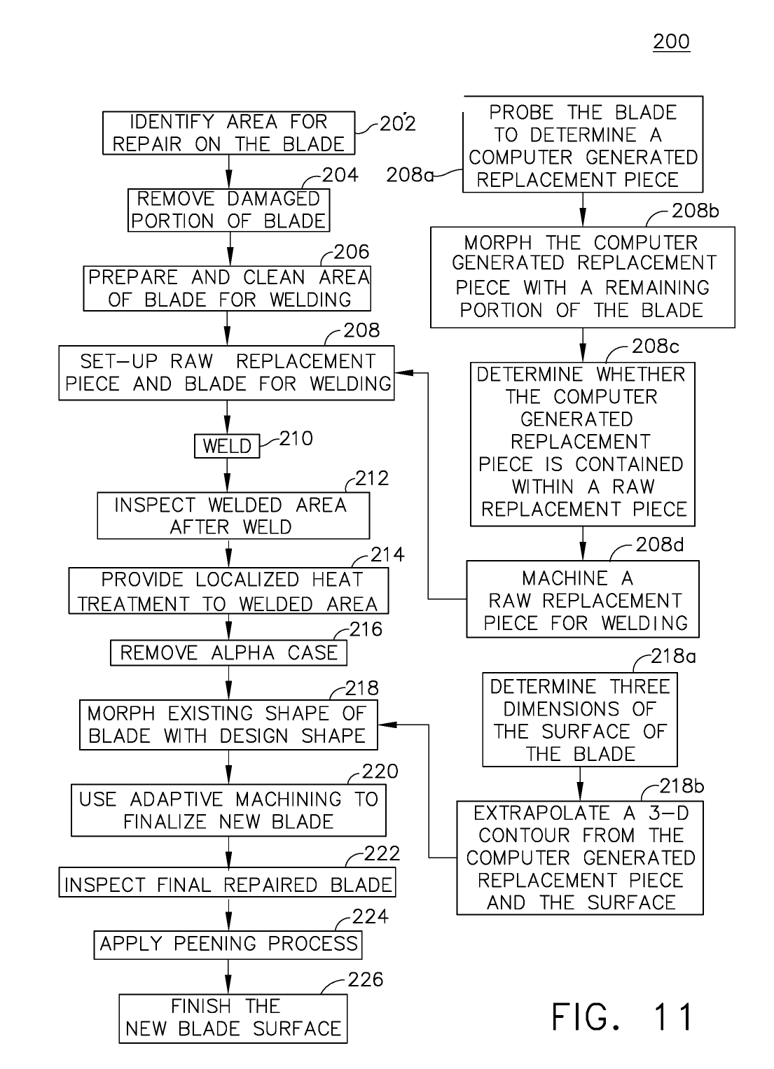

FIG. 11 is a flow chart illustrating a method 200 of repairing the blisk 65 as described herein. The method 200 can include first at 202 identifying an area on the blade 58 requiring repair. Then at 204 removing the damaged portion 112 of the blade 58 to define a severed edge 126. At 206 the blade 58 is prepared and cleaned at the area of the blade 58 where welding will occur. Next at 208 the raw replacement piece 130 and remaining portion 128 of the blade 58 are set up to be welded together. This can include at 208a probing the blade 58 to determine a three dimensional shape of the blade 58, at 208b morphing the remaining portion 128 of the blade 58 to create a computer-generated replacement piece, at 208c determining whether the computer-generated replacement piece 131 is contained within the raw replacement piece 130, and then at 208d machining the raw replacement piece 130. At 210 securing the raw replacement piece 130 to the blade 58 occurs by welding the raw replacement piece 130 to the remaining portion 128 of the blade 58. Upon completion of welding an inspection occurs at 212 of the welded area after which a localized heat treatment is applied at 214. Any alpha case residue left is removed at 216 as described herein.

At 218 morphing an existing shape of the blade 58 with the designed shape as described herein occurs. First at 218a, three dimensions of the surface 156 of the blade 58 are established. Then at 218b a 3-D contour 152 of the surface 156 of the blade 58 is extrapolated from the computer-generated replacement piece 131 and the three dimensions of the surface 156 of the blade 58. Then at 220 shaping the 3-D contour 152 onto the raw replacement piece 130 and using adaptive machining to shape the raw replacement piece 130 and the remaining portion 128 into the repaired blade 150 by machining away excess material 138 from the raw replacement piece 130 to match the extrapolated 3-D contour 152.

Finally, at 222 the repaired blade 150 is inspected. Upon passing inspection a peening process is applied at 224 as described herein. To finalize the repaired blade 150 the surface is finished at 226.

It is contemplated that inspection of the repaired blade 150 can result in failing the repaired blade 150. A different form of welding, by way of non-limiting example gas tungsten arc welding can be applied to further repair the repaired blade 150 in order for the repaired blade 150 to pass inspection. Using a different type of welding process for passing inspection can be applied to address any damaging effects left by, for example, the electron beam welding process. It is contemplated that multiple cut lines (e.g. 114, 116, and 118) are available on a given airfoil and a repaired blade 150 that fails inspection at one cut line can be re-cut at a different cut line after which the SPAD repair process is repeated.

It is contemplated that all portions of the method 200 described herein can occur at one location while the entire blisk 65 is positioned in a machine (not shown), for example a multi-axis milling machine. More specifically, the blisk 65 can remain stationary to ensure data points remain constant and do not require re-setting with on machine probing multiple times. Decreasing the movement of the blisk 65 during repair increases the integrity of the repaired blisk and ensures a more optimal outcome.

Manufacturing an entire blisk can be expensive, therefore methods described herein for repairing the blisk are cost effective and elongate the life of the blisk. Ensuring dimensions of the repaired blisk match the blisk design dimensions and the current dimensions of the blisk allows for optimal performance of the blisk during operation.

Additionally, a blisk formed from a metal material and a repair method including welding are disclosed herein. It is contemplated that the process as described herein can be applied to a blisk formed from a composite material, by way of non-limiting example polymeric composite or ceramic matrix composite. Joining the replacement piece to the blade can be performed with mechanical fastening, adhesive bonding, solvent bonding, co-consolidation, or fusion bonding, also referred to as welding with composites.

It should be appreciated that application of the disclosed design is not limited to turbine engines with fan and booster sections, but is applicable to turbojets and turbo engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of repairing a blisk having a hub with circumferentially spaced blades, the method comprising:
removing a damaged portion of a blade;
probing a blade to determine a three-dimensional shape of the blade;
morphing the remaining portion of the blade to create a computer-generated replacement piece;
determining whether the computer-generated replacement piece is contained within a raw replacement piece;
securing to the blade in place of the removed damaged portion the raw replacement piece;
establishing three dimensions of an existing surface of the blade;
extrapolating a 3-D contour from the three dimensions of the computer-generated replacement piece and the three dimensions of the existing surface of the blade; and
shaping the raw replacement piece to match the extrapolated 3-D contour.

2. The method of claim 1 wherein the probing of the blade to determine a three dimensional shape of the blade comprises determining dimensions that vary along any of a length, width, or height of the blade.

3. The method of claim 1 wherein an additional probing the blade to determine its three-dimensional shape occurs prior to removing the damaged portion of the blade.

4. The method of claim 1 wherein the probing of the blade to determine the three dimensional shape of the blade is generated by probing adjacent blades.

5. The method of claim 1 wherein the morphing the remaining portion of the blade to create the computer-generated replacement piece further includes determining three dimensions of the computer-generated replacement piece.

6. The method of claim 1 wherein the determining whether the computer-generated replacement piece is contained within the raw replacement piece comprises adjusting the raw replacement piece when at least a portion of the computer-generated replacement piece is not contained within the raw replacement piece.

7. The method of claim 6 wherein the adjusting the raw replacement piece includes increasing at least one of the three dimensions.

8. The method of claim 6 wherein the adjusting the raw replacement piece includes machining the raw replacement piece.

9. The method of claim 1 wherein the determining whether the computer-generated replacement piece is contained within the raw replacement piece comprises selecting a new raw replacement piece.

10. The method of claim 1 wherein the shaping the raw replacement piece to match the extrapolated 3-D contour comprises machining away an excess material of the raw replacement piece.

11. The method of claim 1 wherein removing the damaged portion comprises severing the damaged portion from the blade.

12. The method of claim 11 wherein severing the damaged portion comprises severing the damaged portion along with a margin of non-damaged blade.

13. The method of claim 11 wherein the severing forms a severed edge and the raw replacement piece is welded to the severed edge.

14. The method of claim 13 further comprising treating the severed edge prior to welding.

15. The method of claim 14 wherein the treating comprises chemically milling the severed edge in an automated manner.

16. The method of claim 1 wherein the securing the replacement piece comprises maintaining a controlled gap between the blade and the raw replacement piece.

17. The method of claim 16 wherein the controlled gap is filled with weldment.

18. The method of claim 1 wherein the securing the raw replacement piece comprises welding the raw replacement piece to the blade.

19. The method of claim 18 wherein the welding is performed with electron beam welding.

20. The method of claim 18 further comprising heat treating the raw replacement piece after it is welded to the blade.

21. The method of claim 20 further comprising inspecting the weld after completion of the weld and prior to heat treating.

22. The method of claim 20 wherein the heat treating comprises locally heat treating the raw replacement piece and not all of the blade.

23. The method of claim 20 further comprising removing an alpha case from the heat-treated replacement piece in an automated manner.

24. The method of claim 1 further comprising inspecting a repaired blade.

25. The method of claim 24 further comprising failing the repaired blade.

26. The method of claim 25 further comprising repairing the repaired blade by applying a different securing method.

27. The method of claim 26 wherein the different securing method is gas tungsten arc welding.

28. A method of repairing a blisk having a hub with circumferentially spaced blades, the method comprising:
severing a damaged portion of a blade to define a severed edge;
determining three dimensions of a computer-generated replacement piece;
securing to a remaining portion of the blade in place of the damaged portion a raw replacement piece greater in size in three dimensions than the damaged portion;
determining whether the three dimensions of the computer-generated replacement piece are contained within the raw replacement piece_{;}
welding the raw replacement piece to the remaining portion of the blade along the severed edge;
establishing three dimensions of an existing surface of the blade;
extrapolating a 3-D contour from the three dimensions of the computer-generated replacement piece and the three dimensions of the existing surface of the blade; and
shaping the raw replacement piece to match the extrapolated 3-D contour.

29. The method of claim 28 wherein the determining three dimensions of a computer-generated replacement piece includes probing the blade before, after, or both before and after severing a damaged portion of the blade.

30. The method of claim 28 wherein the determining three dimensions of a computer-generated replacement piece includes morphing the remaining portion of the blade to create the computer-generated replacement piece.

31. The method of claim 28 wherein the determining whether the three dimensions of the computer-generated replacement piece are contained within the raw replacement piece comprises adjusting the raw replacement piece when the three dimensions of the computer-generated replacement piece are not contained within the raw replacement piece.

32. The method of claim 31 wherein the adjusting the raw replacement piece includes increasing at least one of the three dimensions.

33. The method of claim 31 wherein the adjusting the raw replacement piece includes machining the raw replacement piece.

34. The method of claim 28 wherein the determining whether the three dimensions of the computer-generated replacement piece are contained within the raw replacement piece comprises selecting a new raw replacement piece.

35. The method of claim 28 wherein the shaping the raw replacement piece to match the extrapolated 3-D contour comprises machining away an excess material of the raw replacement piece.

36. The method of claim 28 further comprising treating the severed edge prior to welding.

37. The method of claim 36 wherein the treating comprises chemically milling the severed edge.

38. The method of claim 28 wherein the welding the replacement piece comprises maintaining a controlled gap between the blade and the raw replacement piece for filling the gap with weldment.

39. The method of claim 28 further comprising heat treating the raw replacement piece after it is welded to the blade.

40. The method of claim 39 further comprising removing an alpha case from the heat-treated replacement piece.

41. The method of claim 39 further comprising at least one of: inspecting the weld after completion of the weld and prior to heat treatment, dimensionally inspecting the raw replacement piece after machining, peening the blade, and surface finishing the raw replacement piece.

42. The method of claim 41 further comprising failing a repaired blade.

43. The method of claim 42 further comprising repairing the repaired blade by applying a different welding method.
